(19) United States
(12) Patent Application Publication
(10) Pub. No.: US 2022/0142248 A1
(43) Pub. Date: May 12, 2022

(54) Electronic Cigarette With Audible Connection

(71) Applicant: JT International S.A., Geneva (CH)

(72) Inventors: Kyle Adair, Lisburn (GB); Andrew Robert John Rogan, Forres (GB)

(73) Assignee: JT International S.A., Geneva (CH)

(21) Appl. No.: 17/436,132

(22) PCT Filed: Mar. 6, 2020
(86) PCT No.: PCT/EP2020/056116

§ 371 Date: Sep. 3, 2021

(30) Foreign Application Priority Data
Mar. 8, 2019 (EP) 19161642.4

(51) Int. Cl. A24F 40/42; A24F 40/65

(52) U.S. Cl. CPC A24F 40/42; A24F 40/65

(57) ABSTRACT

An electronic cigarette includes an inhaler body and a removable cartridge, the inhaler body having a power unit and a cartridge seating. The cartridge seating includes a cavity arranged to receive the cartridge in a retained position within the cavity in which the cartridge is electrically connected to the power unit. The electronic cigarette further includes a mechanical retaining arrangement having a first retaining element located on the cartridge and a second retaining element located on an inner side wall of the cavity, the retaining elements configured to engage when brought into alignment as the cartridge is inserted into the cavity. The retaining arrangement is shaped such that an insertion force is required to move the retaining elements into engagement, the insertion force sufficient to cause a contact between opposing surfaces of the cartridge and cartridge seating which produces an audible signal when the cartridge moves into the retained position.

The present invention relates to an electronic cigarette, in particular an electronic cigarette able to receive a replaceable cartridge.

### BACKGROUND

Electronic cigarettes are an alternative to conventional cigarettes. Instead of generating a combustion smoke, they vaporize a liquid, which can be inhaled by a user. The liquid typically comprises an aerosol-forming substance, such as glycerin or propylene glycol that creates the vapor. Other common substances in the liquid are nicotine and various flavorings.

The electronic cigarette is a hand-held inhaler system, comprising a mouthpiece section, a liquid store and a power supply unit. Vaporization is achieved by a vaporizer or heater unit which typically comprises a heating element in the form of a heating coil and a fluid transfer element, such as a wick, arranged to transfer fluid from the liquid store to the heating element. Vaporisation occurs when the heater heats up the liquid in the fluid transfer element until the liquid is transformed into vapor. The vapor can then be inhaled via an air outlet in the mouthpiece.

The electronic cigarette may comprise a cartridge seating in the Battery section, which is configured to receive disposable consumables in the form of cartridges. Cartridges comprising the liquid store and the vaporizer are often referred to as “cartomizers”. In this case, the vaporizer of the cartomizer is connected to the power supply unit when received in the cartridge seating such that electricity can be supplied to the heater of the cartomizer to heat the liquid to generate the vapor. Often some form of mechanical mechanism is used to retain the cartridge in the cartridge seating such that it does not fall out and separate from the device.

There exists a problem in such prior art devices in that it is not always clear to a user when the required mechanical and electrical connection has been made such that the device is ready to use. Furthermore, even if one of the mechanical and electrical connection have been made, it is not clear that the other has been established. This can result in the cartridge falling out of the device during use or encouraging the user to exert excessive pressure on the cartridge in an effort to make the connection, causing damage to the components of the device.

A further problem exists in that the mechanical connection between the cartridge and device can result in wear on the surfaces that come into contact. Frequent use can therefore result in a reduction in efficacy of the mechanical connection as the opposing contacting surfaces are worn. More seriously, material can wear off the contacting surfaces and collect in the device. This could result in loose material reaching the vapor stream and being inhaled by a user.

### SUMMARY OF THE INVENTION

It is an object of the present invention to provide an electronic cigarette which makes progress in solving some of the problems of prior art devices identified above.

In a first aspect of the invention there is provided an electronic cigarette comprising an inhaler body and a removable cartridge, the inhaler body comprising: a power unit and a cartridge seating, the cartridge seating comprising a cavity arranged to receive the cartridge in a retained position within the cavity in which the cartridge is electrically connected to the power unit; the electronic cigarette further comprising: a mechanical retaining arrangement comprising a first retaining element located on the cartridge and a second retaining element located on an inner side wall of the cavity, the retaining elements configured to engage when brought into alignment as the cartridge is inserted into the cavity thereby holding the cartridge in the retained position; wherein the retaining arrangement is shaped such that a insertion force is required to move the retaining elements into engagement, the insertion force sufficient to cause a contact between opposing surfaces of the cartridge and cartridge seating which produces an audible signal when the cartridge moves into the retained position.

In this way, because a user must apply at least a threshold insertion force to move the retaining elements into engagement, as the retaining elements engage the user applied force causes the contact between opposing surfaces producing the audible signal. The audible signal provides feedback to the user that the cartridge is mechanically and electrically connected to the inhaler body such that the device is ready for use. Because in the received position the opposing surfaces (which generate the audible signal) are in contact and the cartridge is connected to the power unit, the audible signal can be associated with the electrical connection of the cartridge such that it can provide a reliable indicator that the device is ready for use.

The term “an audible signal” is used to refer to a sound produced by the contact between the opposing surfaces that is audible to the user who has connected the cartridge. Preferably the audible signal comprises a peak intensity of at least 25 dB (logarithmically averaged a-weighted sound pressure level), more preferably at least 40 dB such that the audible signal can be heard by the user in the presence of significant background noise. Preferably the audible signal is a sharp sound of short duration such that it more precisely indicates the point of connection. Preferably the audible signal has a duration of less than 0.5 seconds, more preferably 0.3 seconds or less, most preferably less than 0.2 seconds, where the decreasing duration provides an increasingly reliable indication of the point of mechanical and electrical connection. Preferably the audible signal has a frequency response with an intensity peak between 2.5 kHz and 8 kHz, i.e. preferably there is a peak intensity in one of the following ⅓ octave frequency bands: 2.5 kHz, 3.15 kHz, 4 kHz, 5 kHz, 6.3 kHz or 8 kHz. This ensures that the audible signal is readily identifiable to a user, even against significant environmental background noise. Preferably the overall peak intensity in the ⅓ octave response falls within this frequency range. In other examples the audible signal may have an additional intensity peak within a lower frequency range, for example 100 to 160 Hz.

The opposing contact surfaces may be provided by: a surface of a rim surrounding an opening of the cavity and an opposing surface of the cartridge; the inner base surface of the cavity and the opposing base surface of cartridge; or the surface of a protrusion and the receiving surface of a corresponding recess.

Although the invention is illustrated using the example of an electronic cigarette and a cartridge of liquid aerosol generating material, it is clear that the inventive concepts presented herein are distinct from the specific type of aerosol generating device. Therefore the concept defined above and in the following disclosure can also be realised in any form of aerosol generating device and cartridge or capsule. For example, e-cigarettes or heat-not-burn devices where the cartridge contains any form of aerosol generating material, for example cartridges containing tobacco material or induction heated capsules can equally be used if they comprise they characteristics defined in the appended claims.

The shape of the retaining arrangement may be defined by the shape of the retaining elements and the opposing side walls of the cavity and cartridge. By configuring the shape of the mechanical retaining arrangement to provide a restriction to insertion of the cartridge, a user must apply a threshold insertion force to overcome the restriction in order to insert the cartridge. In this way, the threshold insertion force can be tailored such that, when the restriction is overcome, the continued application of the insertion force by the user causes acceleration of the cartridge into the cavity causing contact between the opposing surfaces at sufficient velocity (and therefore kinetic energy ½mv²) such that the proportion converted to sound energy is sufficient to produce an audible signal. The proportion of kinetic energy converted to sound energy is primarily dependent on the surface hardness. A surface hardness of greater than 50 Brinell hardness value or a hardness Rockwell R-scale value are greater than 75 produces a strong audible signal. In practice, appropriate surface hardness is provided by using a metal or rigid plastic material for each of the opposing contact surfaces.

Preferably the mechanical retaining features comprise: at least one retaining feature configured to hold the cartridge in a first direction; and at least one retaining features arranged to hold the cartridge in a second direction, the second direction substantially perpendicular to the first direction.

Preferably the shape of the retaining arrangement is configured such that after the threshold force is applied by the user, the restriction to insertion is abruptly removed such that the cartridge is caused to accelerate into the retained position under the action of the continued force, i.e. the abruptness is such that the user cannot react to readjust the applied force sufficiently during the time between the restriction being overcome and contact between the opposing surfaces.

Preferably the mechanical retaining arrangement is shaped such that a maximum diameter of a received portion of the cartridge is larger than a minimum diameter of the cavity such that there is a restriction to insertion which is overcome by the insertion force; and the cartridge or inhaler body comprises a flexible material; such that the insertion force causes the cartridge or inhaler body to flex in order to accommodate the larger diameter of the cartridge as it is inserted into the cavity. This provides a straightforward cost effective and reliable way to provide the restriction to insertion to induce the required insertion force.

Preferably the cartridge has a rapidly decreasing diameter following the region with increasing diameter such that the flex is abruptly released causing the cartridge to accelerate into the retained position producing the audible signal. The abrupt decrease in diameter means the restriction is rapidly removed when the threshold force is reached such that the user cannot sufficiently adjust the applied insertion force, causing the opposing surfaces to accelerate together to produce the audible signal.

Preferably either the first or second retaining element comprises a protrusion and the other retaining element comprises a recess configured to receive the protrusion when the cartridge is in the retained position. This provides a reliable, cost effective means to retain the cartridge in the cavity.

The audible signal may be generated by contact between the protrusion and recess as the protrusion drops into the recess or between a base surface of the cartridge and an inner base surface of the cavity. When the opposing surfaces are between a protrusion and recess, the release of flex causes the protrusion to accelerate into the recess causing a contact which can contribute to a stronger audible signal.

Preferably the mechanical retaining arrangement comprises a second protrusion next to the recess such that when the cartridge is inserted the first protrusion must first slide over the second protrusion before being received by the recess. In this way a restriction to insertion of the cartridge is provided by the opposing protrusions being brought into contact. By placing the second protrusion immediately adjacent to the recess on the leading edge of the recess, once the protrusion is overcome the restriction is rapidly removed and the first protrusion is accelerated through a greater distance by the release of flex.

Preferably the first and/or second protrusion comprises an angled leading face arranged to meet the other protrusion such that an increasing insertion force is required to move the first protrusion past the opposing second protrusion. By providing an angled leading face, the force required to move the cartridge further into the cavity is increased gradually, allowing for a smooth insertion and engagement of the protrusion and recess. It also reduces high friction and/or shearing forces on the edge of the protrusion which could result in wear and the possibility of material being dislodged and collecting in the device where it might get into the vapour stream.

Preferably the inhaler body or cartridge is configured such that it flexes to allow the first and second protrusion to slide past each other. In this case the insertion force is significantly dependent on the force necessary to cause the walls to flex to allow the cartridge to enter the chamber. When the flex is released the elastic force can contribute to the acceleration of the contact force together to enhance the audible signal.

Preferably the second protrusion comprises: an angled rear face leading into the recess, the angle of incline of the rear face being steeper than that of the leading face such that the protrusion drops abruptly into the recess when brought into alignment. This abruptly releases the flex in the inhaler body or cartridge producing a force on the protrusion which propels the cartridge into the retained position enhancing the audible signal.

Preferably the mechanical retaining arrangement further comprises a third protrusion positioned on a side wall of the cartridge or inner side wall of the cavity, the third protrusion protruding in a direction substantially perpendicular to the first protrusion; wherein the third protrusion is configured to cause the cavity or cartridge to flex so as to push the first protrusion and recess together. This assists in retaining the cartridge in two substantially orthogonal directions. It further increases the restriction to insertion so that the user applied force is greater so as to increase the acceleration of the cartridge when the restriction is released. The provision of a third protrusion further ensures cartridge flexes to properly engage the first protrusion and the first recess so to lock cartridge in position and make it more difficult for it to accidently fall out. Furthermore, the third protrusion acts to provide positive sensation (Haptic feedback) to the user to indicate that the cartridge is seated correctly.

Preferably the third protrusion is arranged such that the cartridge or cartridge seating flexes such that the first or second protrusion is pushed outwards against its opposing side wall as the cartridge is inserted. By providing a flexible cartridge with the second protrusion on one side wall and the third protrusion on an orthogonal side wall, when the third protrusion flexes inwards to allow the cartridge to be accepted into the cavity, the second protrusion is displaced outwards causing a tighter engagement with the first protrusion on the inner side wall of the cavity.

Preferably the third protrusion is positioned on the cartridge and is configured to meet a rim around the opening to the cavity; wherein the third protrusion contacts the rim and causes the cartridge or cavity walls to flex such that the third protrusions can be received by the cavity.

Preferably the third protrusion has a gradually sloping leading edge such that an increasing force is required to insert the cartridge, the force causing the cartridge or cavity to increasingly flex to bring the first protrusion and recess closer together.

Preferably the third protrusion is provided as a wedge shaped profile of the received portion of the cartridge, the wedge shaped profile being in a plane substantially perpendicular to the direction of contact between the first protrusion and recess.

By providing a gradually sloping leading edge on the protrusion, i.e. a wedge shape, the thin end of the wedge shaped protrusion is first received by the cartridge improving the ease with which it is accepted by the opening of the cavity. This shape of protrusion means a gradually increasing insertion force is required to insert the cartridge into the cavity which reduces any abrupt forces applied to the rim and means the cartridge flexes in a smooth gradually increasing manner as the cartridge is inserted. This prevents wear and the degree of initial force required by the user.

The cavity may comprise a second recess arranged to engage with the third protrusion, thereby improving the retaining force. The third protrusion and second recess may provide a second audible signal. Preferably the second protrusion and second recess are arranged such that: they engage at substantially the same time as the first protrusion and first recess during insertion of the cartridge; or they engage before the first protrusion and first recess engage.

By engaging at substantially the same time a single audible signal is generated providing the user with clear confirmation of the mechanical and electrical connection of the cartridge. By proving the third protrusion such that it engages before the first protrusion, the release of flex caused by the third protrusion can propel the cartridge into the first protrusion, reducing the amount of force required to engage the first protrusion with the corresponding recess.

Each of the first, second and third protrusions may comprise multiple protrusions, for example two protrusions positioned on opposite sides of the cartridge or cavity. Each of the first and second recesses may comprise multiple recesses, for example two recesses positioned on opposite sides of the cartridge or cavity. For example, the first protrusion comprises two opposing protrusions positioned on opposing inner surfaces of the cavity side wall, the first recess comprises two recesses positioned on opposite outer surfaces of the cartridge so as to engage with the two first protrusions.

Preferably at least one protrusion comprises an annular ridge extending around the circumference of the cartridge. This can be used to spread the applied force around the circumference of the cartridge, to provide the required flex with a smaller height of protrusion, such that the capsule can be introduced in a smoother manner into the cavity. The annular ridge preferably has a smoothly rounded edge to improve the ease of which it is accepted by the rim around the opening to the cavity.

Preferably the annular ridge has a height between 0.3 and 3 mm. This provides a strong retention of the cartridge whilst reducing the insertion force required.

Preferably the thickness of the outer walls of the cartridge is reduced in a region either side of the protrusion in the axial direction of the cartridge. By locally decreasing the wall thickness either side of the protrusion the side wall of the cartridge or cavity can flex in the intended areas but maintains a desired degree of rigidity in other regions.

Preferably the cartridge seating further comprises a rim surrounding the opening to the cavity, the rim having a rounded inner edge.

### BRIEF DESCRIPTION OF THE DRAWINGS

FIGS. 1a and 1b show an electronic cigarette according to the present invention;

FIG. 2 shows a cartridge in the retained position within the cartridge seating of an electronic cigarette according to the present invention;

FIGS. 3a to 3c illustrate the deformation of the cartridge due to the force produced by protrusions on the cartridge;

FIGS. 4a to 4d illustrate various alternatives for the mechanical retaining arrangement of the electronic cigarette according to the present invention;

FIG. 5 illustrates an alternative mechanical retaining arrangement of the electronic cigarette according to the present invention;

FIG. 6 illustrates an alternative cartridge for the electronic cigarette according to the present invention;

FIG. 7 illustrates a cross section through the side wall of the cavity or cartridge of the electronic cigarette according to the present invention.

### DETAILED DESCRIPTION

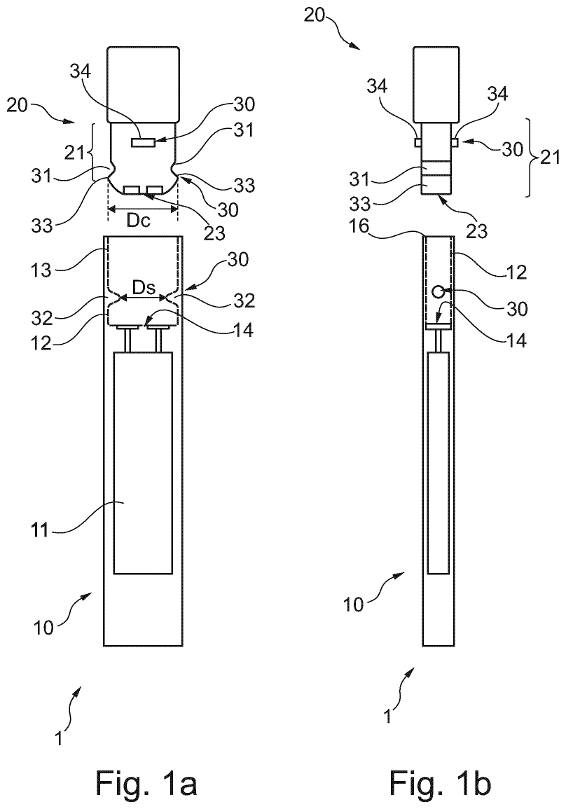

FIGS. 1a and 1b schematically illustrate an electronic cigarette 1 according to the present invention. The electronic cigarette 1 comprises an inhaler body 10 and a removable cartridge 20 which is configured to be received by the inhaler body 10. The inhaler body 10 includes a power unit 11 and a cartridge seating 12, the cartridge seating 12 including a cavity 12 arranged to receive the cartridge 20 in a retained position within the cavity 12. When the cartridge 20 is in the retained position, the cartridge 20 is electrically connected to the power unit 11. The electronic cigarette 1 further includes a mechanical retaining arrangement 30 comprising a first retaining element 31 located on the cartridge 20 and a second retaining element 32 located on an inner side wall of the cavity 12. The retaining elements 31, 32 are configured to engage when brought into alignment as the cartridge 20 is inserted into the cavity 12, the engagement holding the cartridge 20 in the retained position.

The retaining arrangement 30 is shaped such that a user must apply an insertion force in the direction of insertion in order to move the retaining elements 31, 32 into engagement. The shape of the constituent elements of the retaining arrangement 30 is such that the required insertion force is sufficient to cause a contact between opposing surfaces of the cartridge 20 and cartridge seating 12 which produces an audible signal when the cartridge moves into the retained position. In particular, the retaining arrangement 30 is shaped so as to provide an initial restriction to insertion of the cartridge 20. The user must apply a force in the insertion direction above a threshold to overcome this restriction. This threshold force is sufficient such that, once the restriction is overcome, the force causes the cartridge 20 to accelerate into the retained position causing a contact between opposing surfaces of the cartridge 20 and the cartridge seating 12. This abrupt contact produces a sound which provides feedback to the user that the cartridge 20 is both mechanically and electrically coupled to the inhaler body 10.

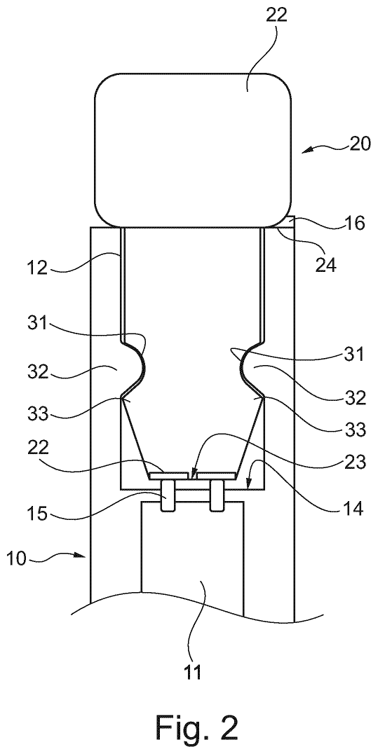

In the example of FIGS. 1a and 1b, the mechanical retaining arrangement 30 is provided by two protrusions 32 provided on opposing inner side walls of the cavity 12 which project out towards each other in a direction substantially perpendicular to the surface of the side wall 13 of the cavity 12. The retaining arrangement 30 also includes two corresponding recesses 31 which are positioned on the outer side walls of the received portion 21 of the cartridge 20 and are positioned and configured so as to engage with the corresponding protrusions 32 on the inner side wall of the cavity 12. The protrusions 32 of the cavity 12 define a minimum diameter D_{S} of the cavity which is smaller than the corresponding maximum diameter D_{c} of the cartridge 20. The protrusions 32 thereby provide a restriction to insertion of the cartridge 20 which must be overcome to bring the cartridge 20 into the retained position, as shown in FIG. 2.

The walls of the chamber 12 or the walls of the received portion 21 of the cartridge 20 are suitably flexible such that either the chamber 12, the cartridge 20 or both flex under the influence of the insertion force to allow the cartridge 20 to overcome this restriction to entry and move past the protrusions 32 such that the protrusions 32 are received in the recesses 31 to retain the cartridge in the retained position shown in FIG. 2. In the example of FIGS. 1 and 2, the mechanical retaining arrangement 30 also includes a second set of protrusions 33 which are positioned next to the recesses 31 on a leading side (i.e. closer to the base of the cartridge such that they enter the cavity 12 before the recesses). The protrusions 31 of the cartridge cavity 12 therefore meet the second set of protrusions 33 before the recesses 33 as the cartridge 20 is inserted, increasing the restriction to entry of the cartridge 20. In particular, as the cartridge 20 is inserted into the cavity 12, the protrusions 33 of the cartridge 20 first meet the protrusions 32 on the inner surface 13 of the cavity 12 and the second set of protrusions 33 must slide past/over the protrusions 32 of the cavity 12 in order for the protrusions 32 of the cavity 12 to be received by the recesses 31. In this way, an increased threshold insertion force is required to move the cartridge 20 into the cavity 12, as the maximum diameter of the received portion 21 of the cartridge 20 is increased by the radial projection of the protrusions 33.

When the protrusions 33 of the cartridge 20 meet the inner protrusions 32 of the cavity 12, the user must apply a force in the insertion direction of the cartridge 20 above a threshold which allows for the protrusions to slide past each other. At least a portion of the cartridge 20 (for example the received portion 21) is made of a flexible material such that a shape of the cartridge can distort to allow it to pass by the restriction in diameter provided by the cavity protrusions 32. The input force by the user therefore produces a flex in the received portion 21 of the cartridge which reduces the maximum diameter D_{C} allowing it to move past the cavity protrusions 32.

As soon as the protrusions 33 of the cartridge 20 move past the corresponding protrusions 32 of the cavity the restriction is abruptly removed and the flex in the cartridge is released which causes the cartridge to accelerate towards the bottom surface 14 of the cavity 12 under the applied user force. The movement of the cartridge is abruptly stopped by contact between the opposing surfaces of the cartridge 20 and the inner base surface 14 of the cavity 12. This abrupt contact produces a strong audible signal which indicates to the user that the cartridge is in the received position as shown in FIG. 2.

As shown in FIG. 2, when the cartridge 20 is in the retained position of the chamber 12, the inner cavity protrusions 32 are received by the recesses 31 of the cartridge 20 retaining the cartridge securely in the cavity 20. In this position the electrical contacts 22 of the cartridge 20 are in contact with corresponding contacts 15 at the base of the cartridge seating 12 connecting a heater (not shown) within the cartridge 20 to the power supply 11 of the inhaler body 10. The audible signal therefore provides feedback to the user that the cartridge 20 is mechanically retained within the cartridge seating 12 with the heater of the cartridge 12 connected to the power supply 11, such that the device 1 is ready for use.

In the example of FIGS. 1a and 1b the opposing surfaces of the cartridge and cartridge seating 12 which provide the impact noise/sound (the audible signal) are the base surface 14 of the cavity 12 and the bottom surface 23 of the cartridge, i.e. the contacting surfaces in which the electrodes 15, 22 are located provides the mechanical connection resulting in the audible signal. In other examples, for example in the arrangement of FIG. 2, the contact is provided between the rim 16 around the opening to the cavity 12 in the inhaler body 10 and the opposing rim 24 provided by the increased radial extension of the mouthpiece portion 25 of the cartridge 20. Alternatively or additionally the contact between the protrusions 32 of the side wall of the cavity and the recesses of the cartridge as they snap into place may contribute to the audible signal generated.

The opposing surfaces have sufficient surface hardness that a significant proportion of the kinetic energy provided by the motion of the cartridge into the retained position is transformed into sound energy. For example, a surface hardness of greater than 50 Brinell hardness value or a hardness Rockwell R-scale value are greater than 75 produces a strong audible signal. In practice, appropriate surface hardness is provided by a metal or rigid plastic material. In particular, a peak intensity of the noise created by impact is preferably greater than 25 dB, preferably greater than 40 dB to provide a reliable audible signal of sufficient strength.

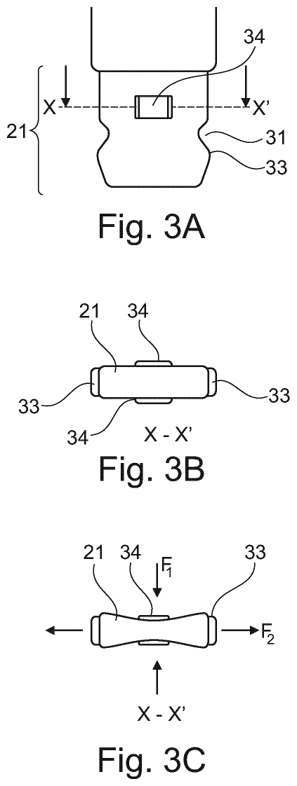

The electronic cigarette 1 according to the present invention may also include additional features within the mechanical retaining arrangement 30 directed at enhancing the audible signal and connection of the cartridge in the cavity 12. As shown in FIGS. 1a and 1b the cartridge 20 may include another set of protrusions 34 which extend in a direction substantially perpendicular to the second set of protrusions 33. In the example of FIG. 1, the cartridge has a substantially rectangular cross section with the second set of protrusions 33 extending from two opposing side faces and the third set of protrusions 34 extending from the other two opposing side faces. Cartridges 20 of other cross sectional shapes may also use an additional set of protrusions 34, the important aspect being that the third set of protrusions 34 extend substantially perpendicularly to the second set of protrusions 33 so as to encourage the cartridge to flex, as will be described with reference to FIGS. 3a to 3c.

As shown in FIG. 1b, the third set of protrusions 34 extend outwardly from the side face of the received portion 21 of the cartridge 20 by a sufficient distance that, as the cartridge 20 is inserted into the cavity 12, the third set of protrusions 34 meet the rim 16 around the opening of the cavity as the width of the cartridge at the protrusions 34 is wider than the opening to the cavity 12. The user must therefore apply a force in the insertion direction which causes the received portion 21 of the cartridge 20 to flex allowing the protrusions 34 to move inwardly such that they may be accepted by the opening to the cavity 12.

FIG. 3a shows a side view of the received portion 21 of the cartridge 20 and FIGS. 3b and 3c show a cross section through the received portion 21 of the cartridge as indicated by the line X-X′ shown in FIG. 3a. As shown in FIG. 3b, before the cartridge is inserted into the cavity 12, when it is in a relaxed state, the third set of protrusions 34 extends in a direction substantially perpendicular to that of the second set of protrusions 33. As the third set of protrusions 34 meet the rim 16 around the cavity 12, the continued pressure by a user in the insertion direction causes the flexible material of the received portion 21 of the cartridge 20 to inwardly flex in the direction F1 shown in FIG. 3c in order that the protrusions 34 can move past the rim into the cavity 12. The flexing of the cartridge in the direction F1 causes the cartridge to additionally distort such that the width of the received portion 21 of the cartridge 20 increases in the direction F2. In other words, the inward flexing of the cartridge 20 causes an outward displacement of the second set of protrusions 33 in an orthogonal direction. Returning to FIG. 1a, it is clear that the outward displacement of the protrusions 33 will cause them to press into the inner side walls 13 of the cavity 12 with a greater force. This increases the tightness of the connection of the mechanical retaining arrangement 30 and means that a user will have to apply a greater force to slide the protrusions 33 of the cartridge 20 over the protrusions 32 of the cavity 12. The fact that an increased insertion force is required means that when the protrusions slide past each other such that the restriction is abruptly released the accelerating force on the cartridge 20 is greater which means a greater impact between the opposing surfaces of the cartridge and cavity 12, increasing the intensity of the audible signal generated.

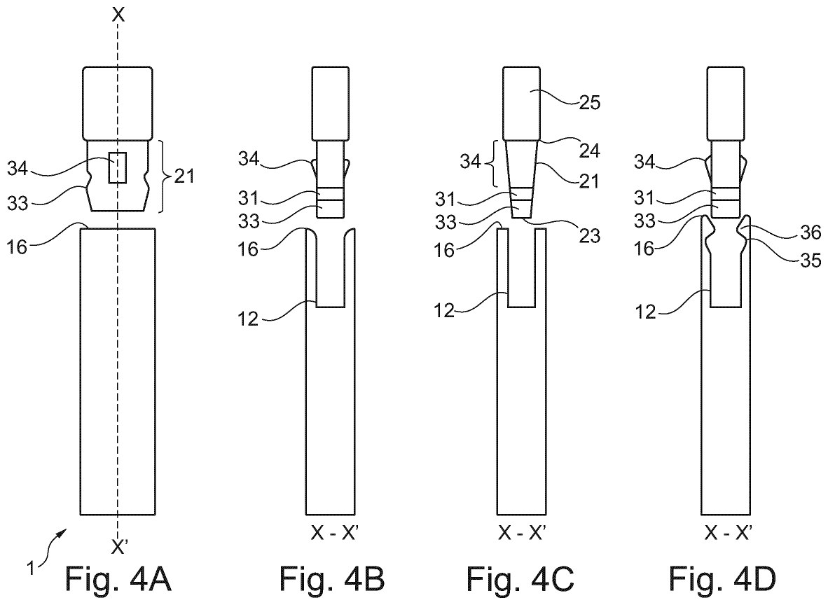

FIGS. 4a to 4d show various alternatives for the shape of the third set of protrusions 34, configured to cause the received portion 21 to flex such that the second set of protrusions 33 are pushed outwards in order to increase the tightness of the engagement between the protrusions 33 and recesses 31 of the cartridge 20 with the protrusion 32 on the inner side wall 13 of the cavity 12. FIG. 4a shows an outer side view of a device 1 according to the present invention. The electronic cigarette 1 of FIG. 4a is the same as that of FIG. 1a apart from various alternatives for the third set of protrusions 34 may be provided as shown in the cross sections of FIGS. 4b to 4d.

FIGS. 4a and 4b show an alternative to the protrusions 34 in FIG. 1b in that the protrusions have an angled leading edge which is gradually sloping to improve the ease with which the third set of protrusions 34 engage with the rim 16 around the opening to the cavity 12 in particular if the rim 16 or the protrusions 34 have an abrupt leading edge a large force must be applied initially in the insertion direction and this is not optimally transferred into the required flex of the cartridge 20 that the protrusions 34 can be accepted by the cavity 12. This results in large sheering forces being applied to these contact points which can result in heavy wear of these edges and the possibility of loose material being dislodged which could collect in the cavity and move into the vapour stream.

A number of steps can be taken to avoid these issues and improve the engagement between the cartridge and the cavity to promote the required flexing of the cavity or cartridge 20 and reduce friction between the contact edges. By providing a gradually sloping leading edge on the protrusion, i.e. a wedge shape, the thin end of the wedge shaped protrusion is first received by the cartridge improving the ease with which it is accepted by the opening of the cavity 12. This shape of protrusion 34 means a gradually increasing insertion force is required to insert the cartridge 20 into the cavity 12 which reduces any abrupt forces applied to the rim 16 and means the cartridge 20 flexes in directions F1 and F2 (shown in FIG. 3c) in a smooth gradually increasing manner as the cartridge is inserted. Therefore the force of the second set of protrusions 33 against the inner walls 13 of the cavity 12 is gradually increased as the cartridge is inserted, preventing wear and the degree of initial force required by the user.

Another problem solved by this arrangement is that, if the second set of protrusions 34 has an abrupt edge as shown in FIG. 1b, a significant force must be applied by the user which, when it reaches above the required threshold, causes the received portion 21 of the cartridge 20 (or the walls of the cavity 12) to deform abruptly as the protrusions 34 are suddenly received by the cavity 12. The abrupt movement of protrusions 34 into the cavity can produce an audible signal in the form of a noise or “click” which can be confused with the audible signal indicative of electrical contact between the contacts 15, 22. This means, (i.e. if there are multiple clicks or noises during insertion of the cartridge) that it may not be clear to the user when secure mechanical and electrical contact has been achieved. By providing a smoothly angled set of protrusions 34 there is no abrupt entry of the cartridge which can result in an initial audible signal.

Similar advantages are provided by the alternative structures shown in FIGS. 4b to 4d. Firstly, the rim 16 around the opening to the cavity 12 may have a rounded or angled edge, angled outwardly to accept the cartridge 20. This rounded or angled edge again prevents the above described disadvantages in terms of having two parallel contact edges resulting in a sudden acceptance of the cartridge and protrusions 34 into the cavity 12. As shown in FIG. 4b the smoothly rounded rim 16 may be provided in addition to the angled protrusions 34 to further smooth the insertion of the cartridge 20. Alternatively, the third protrusion 34 may be provided in the form of a wedge shaped profile of the received portion 21 cartridge 20 as shown in FIG. 4c, in which the width of the cartridge (in a direction perpendicular to the engaging protrusions 33) gradually increases from the bottom surface 23 of the cartridge to the rim at which the mouthpiece portion 25 meets the received portion 21. Again, this arrangement provides the advantages described above and may be provided with a rounded rim 16 around the opening to the cavity 12 or with straight edges, the latter shown in FIG. 4c.

A variation to the arrangement of FIG. 4b is shown in FIG. 4d. In this example the protrusions 34 have an angled leading edge and back edge. Furthermore, the inner walls of the cavity 12 (i.e. the side walls which are orthogonal to side walls 13 shown in FIG. 1a) have an additional set of recesses 35 arranged to receive the third set of protrusions 34 of the cartridge. These recesses 35 can be arranged to receive the third set of protrusions 34 at the same time that the first set of protrusions 32 are received by the first set of recesses 31. In this way, two sets of recesses 31, 35 and protrusions 33, 34 on orthogonal sides of the cartridge and cavity 12 side walls are received simultaneously. This can firstly increase the threshold insertion force required for the user to overcome the restriction to insertion of the cartridge 20 (as the cartridge 20 experiences a restriction in both orthogonal directions of the cross sectional opening to the chamber 12). This encourages an even greater insertion force to be applied which results in a greater audible signal as the opposing surfaces of the cartridge 20 and cartridge seating 12 contact to produce the audible signal, while still ensuring a smooth insertion as the force required increases gradually due to the incline of the protrusions 34. Furthermore, if the mechanical retaining arrangement 30 is configured to contribute to the audible signal as the protrusions 34, 33 are abruptly received in the recesses 35, 32 the intensity of the audible signal will be further increased.

The side wall of the cartridge 20 may further include another set of protrusions 36 configured to contact the third set of protrusions 34 before they are received in the recesses 35, in a similar way to the first set of protrusions 32, 33. The electronic cigarette 1 of FIG. 4d therefore provides an increased security of engagement between the cartridge 20 and the power unit 10 due to the engagement of protrusions in orthogonal directions on all sides of the cartridge 20 and inner side walls 13 of the cavity 12.

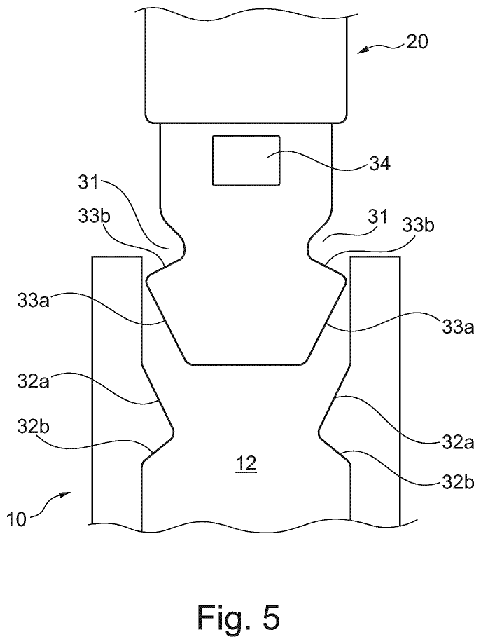

FIG. 5 illustrates how the shape of the protrusions 32, 33, 34, 36 may be configured to optimise the engagement between the cartridge and the cartridge seating 12 and enhance the audible signal generated as the cartridge 20 is received in the cavity 12. FIG. 5 shows a cross section through the cartridge 20 and upper portion of the inhaler body 10 with the cartridge 20 partially inserted into the cavity 12. The protrusions 32 positioned on the inner side walls of the cavity 12 are shaped so that they have an angled leading face 32a on side of the protrusion which first meets the cartridge 20 as it is inserted into the cavity and an angled rear face 32b on the opposite side of the protrusion which holds the cartridge in the retained position as shown in FIG. 2. The engagement of the cartridge can be optimised by providing a set of protrusions 32 with a shallower angled leading face 32a and a small steeply inclined rear face 32b. In this way, as the cartridge meets the leading face 32a of the protrusion 32, a gradually increasing force is required in order to deform the cavity side walls or the walls of the cartridge 20 sufficiently for the cartridge to pass through the constricted diameter of the cavity 12. This provides a smooth entry of the cartridge in which the user is encouraged to apply an increasing force to move the received portion 21 of the cartridge 20 past the protrusions 32 of the cavity 12.

As the leading face of the cartridge moves past the peak of the protrusion between the leading edge 32a and the rear edge 32b, the steeply inclined rear face 32b of the protrusion 32 means the flex in the cartridge 20 is abruptly released. This has a number of advantages. Firstly, the abrupt release of the flex provided by the shape of protrusion 32 can itself generate a force which propels the cartridge 20 downwards in the insertion direction into the cavity 12. This encourages the cartridge into the engaged position in which the protrusions 32 are received by the recesses 31 and also increases the speed with which the cartridge 20 is propelled into contact producing the audible signal. An additional effect is that, as the user is encouraged to provide an increasing force to move the cartridge past the leading edge 32a of the protrusion 32, when this is abruptly removed (due to the rapid decrease in diameter of the cavity provided by the rear edge 32b) the user does not have time to adjust the force which means they continue to apply a force which drives the cartridge into the retained position, causing contact between the opposing surfaces as described above increasing the intensity of the audible signal generated.

These effects can further be improved by providing a corresponding shape to the protrusions 33 of the cartridge 20. In particular, by providing a gradually inclined leading face 33a and a steeply declining rear face 33b the effect is amplified as the restriction on insertion of the cartridge is rapidly removed, enhancing the effects described above. Although, the adapting of the shape of the protrusions has been described with respect to protrusions 32 and 33, this can also be applied to the protrusions on the orthogonal size of the cartridge 33 and 34. Furthermore, the protrusions may be placed so that the propelling force derived from the release of flex described above can propel the cartridge into the second set of protrusions, thereby reducing the amount user input force required to move the cartridge into the retained position. The protrusion may have an angular incline relative to the elongate axis (the insertion direction) of between 5 and 45 on the leading edge 32a, 33a and between 45 and 90 on the rear edge 32b, 33b.

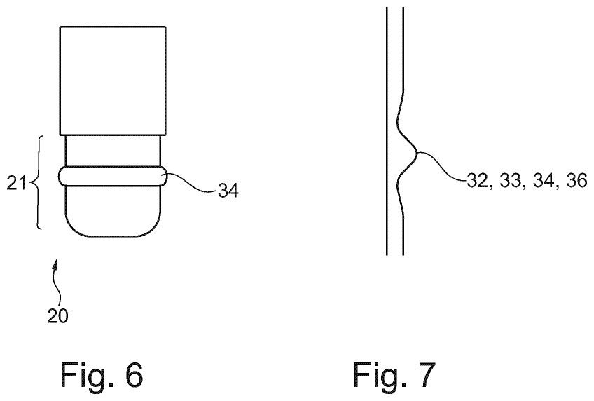

In an alternative arrangement of the device the protrusion 34 on the cartridge 20 may be provided as an annular ridge 34 extending around the circumference of the cartridge 20, as illustrated in FIG. 6. This can be used to spread the applied force around the circumference of the cartridge, to provide the required flex with a smaller height of protrusion, such that the capsule can be introduced in a smoother manner into the cavity 12. The annular ridge preferably has a smoothly rounded edge to improve the ease of which it is accepted by the rim 16 around the opening to the cavity 12. The annular ridge preferably has a height of less than 5 mm, more preferably less than 2 mm. The annular ridge 34 may be incomplete such that it includes one or more longitudinal channels through the annular ridge 34, which provide channels for air to leave the cavity 12 as the cartridge is inserted, preventing a seal from being formed around the circumference of the cartridge 20 which could impede insertion.

To make the cartridge wall or the side wall of the cavity 12 more flexible to improve the degree to which it can flex as the mechanical retaining arrangement comes into engagement, the thickness of the side wall of the cartridge (the side wall of the liquid store within the received portion 21 of the cartridge 20) or the side wall of the cavity 12 can be reduced in thickness. In particular, a thickness between X and Y provides an enhanced degree of flexibility promoting the above described effects. Alternatively, the thickness of the cartridge side wall or the cavity 12 side wall can be reduced just in the vicinity of the protrusions 32, 33, 34, 36 as shown in FIG. 7. By locally decreasing the wall thickness either side of the protrusion the side wall of the cartridge or cavity 12 can flex in the intended areas but maintains a desired degree of rigidity in other regions.

1. An electronic cigarette comprising an inhaler body and a removable cartridge, the inhaler body comprising:
a power unit and a cartridge seating, the cartridge seating comprising a cavity arranged to receive the removable cartridge in a retained position within the cavity in which the removable cartridge is electrically connected to the power unit; the electronic cigarette further comprising:
a mechanical retaining arrangement comprising a first retaining element located on the removable cartridge and a second retaining element located on an inner side wall of the cavity, the first and second retaining elements configured to engage each other when brought into alignment as the removable cartridge is inserted into the cavity thereby holding the removable cartridge in the retained position; wherein
the mechanical retaining arrangement is shaped such that an insertion force is required to move the first and second retaining elements into engagement, the insertion force sufficient to cause a contact between opposing surfaces of the removable cartridge and the cartridge seating which produces an audible signal when the removable cartridge moves into the retained position.

2. The electronic cigarette of claim 1, wherein the mechanical retaining arrangement is shaped such that a maximum diameter of a received portion of the removable cartridge is larger than a minimum diameter of the cavity such that there is a restriction to insertion which is overcome by the insertion force; and
the removable cartridge or the inhaler body comprises a flexible material; such that
the insertion force causes the removable cartridge or the inhaler body to flex in order to accommodate the maximum diameter of the removable cartridge as the removable cartridge is inserted into the cavity.

3. The electronic cigarette of claim 1, wherein either the first retaining element or the second retaining element comprises a first protrusion and the other of the first and second retaining elements comprises a recess configured to receive the first protrusion when the removable cartridge is in the retained position.

4. The electronic cigarette of claim 3, further comprising a second protrusion next to the recess such that when the removable cartridge is inserted into the cavity the first protrusion must first slide over the second protrusion before being received by the recess.

5. The electronic cigarette of claim 4, wherein the first protrusion and/or the second protrusion comprises an angled leading face arranged to meet the other of the first and second protrusions such that an increasing insertion force is required to move the first protrusion past the second protrusion.

6. The electronic cigarette of claim 4, wherein the inhaler body or the removable cartridge is configured to allow the first and second protrusions to slide past each other.

7. The electronic cigarette of 5, wherein the second protrusion comprises:
an angled rear face leading into the recess, an angle of incline of the angled rear face being steeper than an angle of incline of the angled leading face such that the first protrusion drops abruptly into the recess when brought into alignment.

8. The electronic cigarette of claim 4, further comprising a third protrusion positioned on a side wall of the removable cartridge or the inner side wall of the cavity, the third protrusion protruding in a direction substantially perpendicular to the first protrusion; wherein the third protrusion is configured to cause the cavity or the removable cartridge to flex so as to push the first protrusion and the recess together.

9. The electronic cigarette of claim 8, further comprising a second recess arranged to engage with the third protrusion.

10. The electronic cigarette of claim 9, wherein the third protrusion and the second recess are arranged such that:
they engage at substantially the same time as the first protrusion and the first recess during insertion of the removable cartridge; or
they engage before the first protrusion and the first recess engage.

11. The electronic cigarette of claim 8, wherein at least one of the first, second, and third protrusions comprises an annular ridge extending around a circumference of the removable cartridge.

12. The electronic cigarette of claim 11, wherein annular the ridge has a rounded profile.

13. The electronic cigarette of claim 11, wherein the annular ridge has a height of less than 2 mm.

14. The electronic cigarette of claim 3, wherein a thickness of outer walls of the removable cartridge is reduced in a region on either side of the first protrusion in an axial direction of the removable cartridge.

15. The electronic cigarette of claim 1, wherein the cartridge seating further comprises a rim surrounding an opening to the cavity, the rim having a rounded inner edge.
